(19) United States
(12) Patent Application Publication
(10) Pub. No.: US 2010/0139874 A1
(43) Pub. Date: Jun. 10, 2010

(54) PERFORATED LOUVER WITH DESIGN PATTERN LAYER AND AN ASSEMBLY FOR SUCH LOUVERS

(75) Inventors: Angelo Sudano, Montreal (CA); Benoit Meloche, Blainville (CA)

Correspondence Address: MERCHANT & GOULD PC, P.O. BOX 2903, MINNEAPOLIS, MN, 55402-0903, US

(73) Assignee: Plastibec Inc., Boisbraind (CA)

(21) Appl. No.: 12/635,360

(22) Filed: Dec. 10, 2009

(30) Foreign Application Priority Data
Dec. 10, 2008 (CA) 2,646,144

(51) Int. Cl. E06B 9/262; E06B 9/24

(52) U.S. Cl. 160/236; 160/405

(57) ABSTRACT

A louver includes an integral core having first and second opposed surfaces. There is a layer provided on at least a portion of at least the first surface of the core. The layer has a design pattern with a plurality of projections extending away from the core. The louver is also provided with an array of light-traversable perforations extending through the core and the layer. An assembly that has a support mountable to a frame of an opening and a plurality of louvers. The louvers are mountable relative to the support so that the louvers cover the opening. The assembly also has rotation members for rotating the louvers between a closed position and a partially open position and a fully open position. The projections combined with the perforations allow the louvers to present improved light transmission-reflection effects particularly when rotated.

This application claims benefit of Serial No. 2,646,144, filed 10 Dec. 2008 in Canada and which application is incorporated herein by reference. To the extent appropriate, a claim of priority is made to the above disclosed application.

### FIELD OF THE INVENTION

The present invention pertains to the field of coverings for openings such as windows and doors. The invention more particularly pertains to a louver and an assembly for louvers.

### BACKGROUND

Openings such as windows and doorways are important in the design and functioning of many architectural structures. Depending on their construction, openings can allow the passage of light, sound, matter such as air, and/or heat.

The amount of light that is allowed to pass through an opening can be varied or controlled by a variety of techniques. Window openings are often covered with glass or another transparent or translucent material to allow light passage while minimizing the passage of sound and heat and eliminating mass transfer from one side to the other. Other types of coverings are also widely used to achieve a desired lighting effect. Indeed, many architectural and optical effects may be achieved depending on the amount and color of light that is allowed to pass through an opening. Coverings may provide various and sometimes adjustable effects of decoration, privacy, transparency and ambiance to name a few.

Louvers are one way to cover an opening and vary light transmission. Louvers are most often used as a series of side-by-side slats that may be adjustable or fixed to allow the desired light transmission.

Louvers have been composed of a variety of materials. Louvers made of woven textiles are largely designed for vertical hanging applications as they are quite bendable and not self-supporting. Textile louvers also have various inherent disadvantages such as difficult cleaning and manufacturing inefficiencies. Louvers may also be composed of rigid or semi-rigid plastic resins, wood and light metals such as aluminium.

One-piece louvers have traditionally allowed light transmission by being angled relative to the incident light to enable light to pass in between adjacent louvers. Such louvers have often been adjustable so that by varying their angle the space between each louver can be adjusted and the corresponding light transmission can be controlled.

It has also been known to perforate one-piece louvers to allow light passage through each individual louver via the perforations. The perforated louvers known up to now have had smooth surfaces and have been offered in limited colors i.e. white, off-whites or grey. The known perforated louvers present a variety of disadvantages and inefficiencies, such as poor decorative effects, monochromaticity, dull and sometimes unfavorable light transmission and reflectance effects, among others.

There is a need in the field for a technology that can overcome at least some of the disadvantages of what is already known in the field.

### SUMMARY OF THE INVENTION

The present invention responds to the above-mentioned need by providing a louver and an assembly for louvers.

In one aspect of the present invention, there is provided a louver including an integral core having first and second opposed surfaces; a layer provided on at least a portion of at least the first surface of the core, the layer having a design pattern comprising a plurality of projections extending away from the core; and an array of light-traversable perforations extending through the core and the layer.

In another aspect of the present invention, there is provided an assembly comprising a support mountable to a frame of an opening; a plurality of louvers as defined here-above or herein, the louvers being mountable relative to the support so that the louvers cover the opening; and rotation members for rotating the louvers between at least a closed position and a partially open position.

The projections combined with the perforations allow the louvers to present improved light transmission-reflection effects.

### BRIEF DESCRIPTION OF THE DRAWINGS

FIG. 1 is a plan view schematic of part of a louver according to a preferred embodiment of the present invention.

FIG. 2 is a profile view schematic along line II of FIG. 1.

FIGS. 3a-3d are plan view schematics of parts of louvers according to various optional embodiments of the present invention.

FIGS. 4a-4d are profile view schematics of louvers according to various optional embodiments of the present invention.

FIG. 5 is a close-up cross-sectional view schematic of part of a louver according to a preferred embodiment of the present invention.

FIGS. 6a and 6b are close-up cross-sectional view schematics of the louver of FIG. 5 showing some light transmission effects respectively in a closed position and a partially opened position.

FIGS. 7a and 7b are close-up cross-sectional view schematics of the louver of FIG. 5 showing some light reflectance effects respectively in a closed position and a partially opened position.

FIGS. 8a-8c are profile view schematics of another part of louvers according various optional embodiments of the present invention.

FIG. 9a is a front plan view schematic of an assembly comprising a series of vertical hanging louvers in the closed position, according to another embodiment of the present invention.

FIG. 9b is a front plan view schematic of an assembly comprising a series of horizontal hanging louvers in the closed position, according to yet another embodiment of the present invention.

FIG. 10 is a process flow diagram showing a process of making an embodiment of the louver.

### DETAILED DESCRIPTION OF THE PREFERRED EMBODIMENTS

Referring to FIGS. 1, 2 and 5-8c, various parts and close-up views of a louver 10 are illustrated.

Referring more specifically to FIGS. 5-8c, the louver 10 includes an integral core 12 having first 14 and second 16 opposed surfaces. In an optional embodiment of the louver 10, the core is composed of a thermoplastic resin such as polyvinyl chloride and is manufactured by extrusion or co-extrusion. In another optional embodiment, the first surface 14 and the second surface 16 are generally smooth, which may result from the extrusion or co-extrusion when employed. The core 12 is “integral” in the sense that it forms a single structure. Preferably, the core is a one-piece structure which may be achieved by extruding a single slat-shaped thermoplastic piece or cutting a piece of wood or metal to the desired shape. Alternatively, the core may be integrally constructed from different sub-components that are secured together.

Referring now to FIGS. 1, 2, 5-8c, the louver 10 further includes a layer 18 having a design pattern. The layer 18 is provided on at least a portion of at least the first surface 14 of the core 12. In a preferred embodiment of the louver 10, the layer 18 is provided over the entire first surface 14 of the core 12. The louver 10 is preferably arranged with other louvers 10 to cover an architectural opening so that the first surface 14 of each louver 10 is inward-facing and the second surface 16 is outward-facing. In this way, the layer 18 is also inward-facing to be viewable from within the architectural enclosure or space.

Referring now to FIGS. 5-8c, the layer 18 has a design pattern that includes a plurality of projections 20 extending away from the core 12. The “design pattern” may take on a variety of embodiments be it woodgrain, herringbone, vertical lines, horizontal lines, diagonal lines, chequered, or another type of pattern. The layer 18 may be provided on the core 12 in a variety of ways. In one optional embodiment, the layer 18 is composed of water-based or oil-based colorant that is applied onto the core 12 in the desired design pattern. For instance, in the case that the core 12 is an extruded thermoplastic resin, the colorants may be transferred onto it using an anilox roller and gravure printing roller combination. In another optional embodiment, the layer 18 may be composed of a thermoplastic resin that is co-extruded with the core 12. In some embodiments, the layer 18 may be formed by embossing the extruded slat, thereby producing the projections 22 defined by embossing grooves. It should be understood that layer 18 producing techniques may be combined so that coloring, embossing, gravure printing, film application, etching, among other methods, may be used in various iterations and permutations to produce the layer 18 on the core 12.

The projections 20 may have a variety of forms, dimensions and locations, as will be further discussed hereinbelow.

Referring now to FIGS. 1, 3a-3d and 5-8c, the louver 10 further includes an array of light-traversable perforations 22.

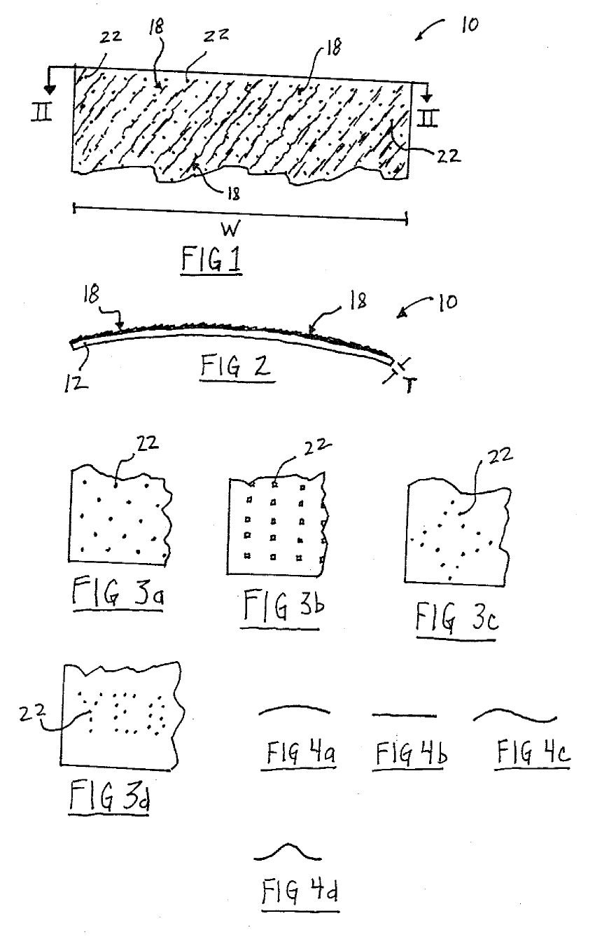

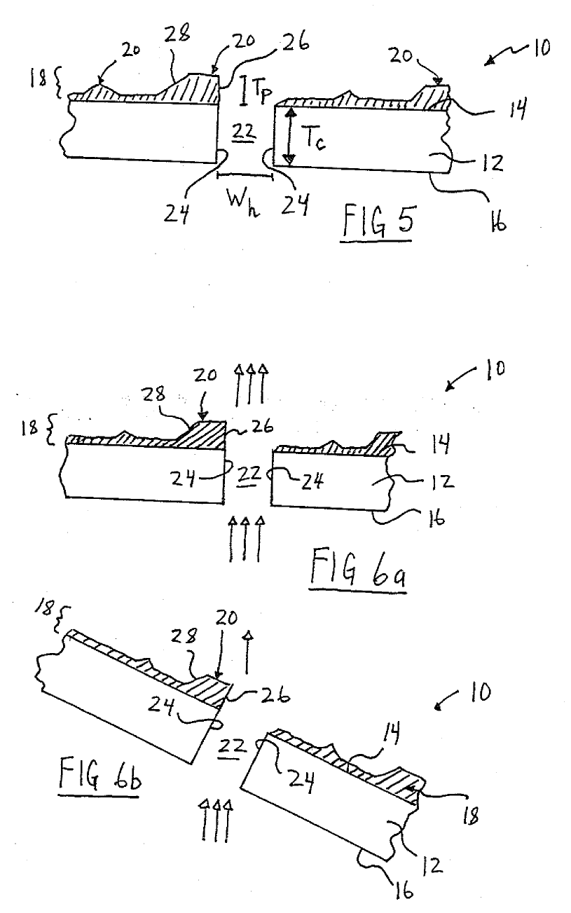

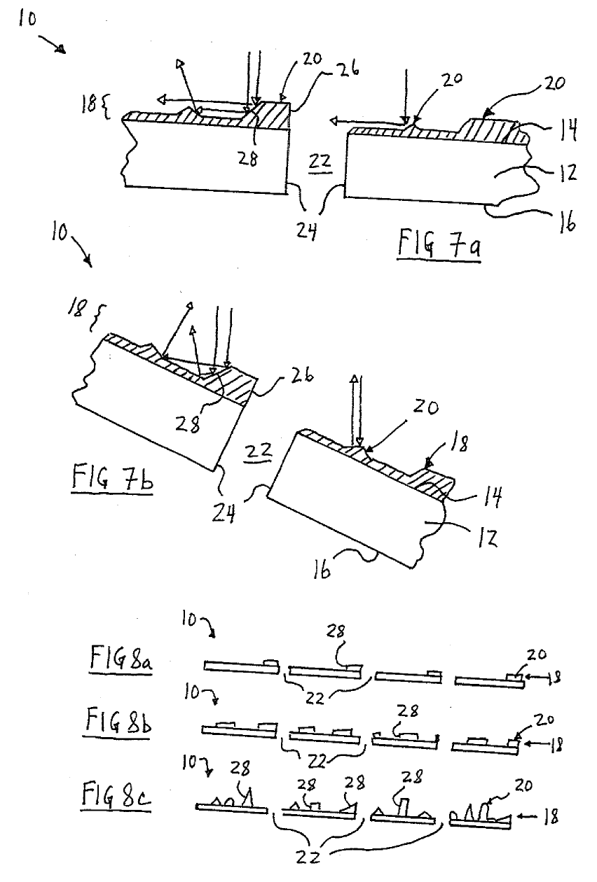

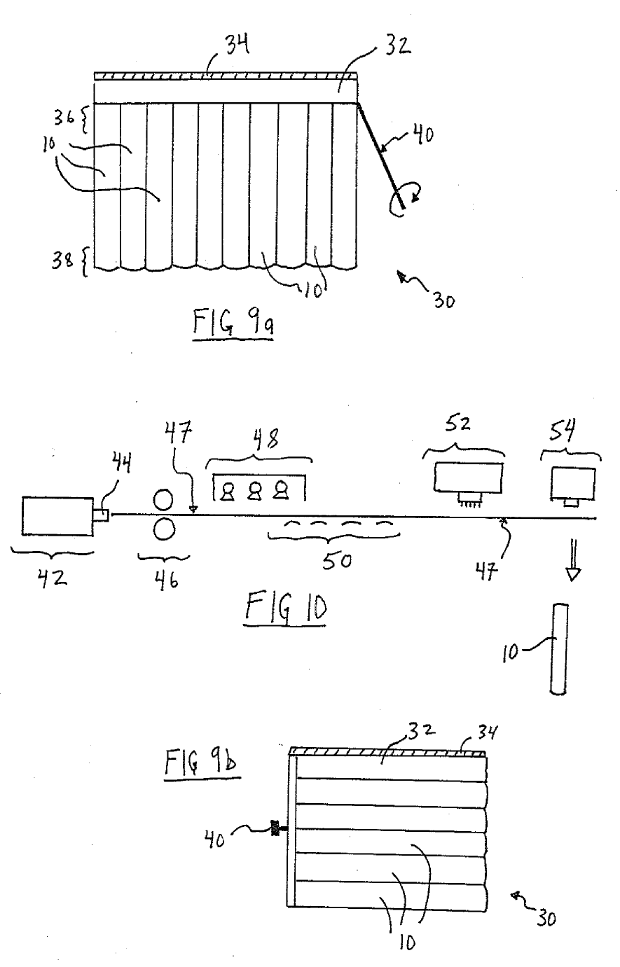

Referring in particular to FIGS. 5-8c, the perforations 22 extend through both the core 12 and the design pattern layer 18. The array of perforations 22 may have a variety of characteristics. For instance, the array of perforations 22 may have a staggered pattern type as illustrated in FIGS. 1 and 3a, a straight pattern type as illustrated in FIG. 3b, or a random pattern (not illustrated). The array of perforations 22 may alternatively be provided to have an ornamental shape as illustrated in FIG. 3c. The ornamental shape of the array, which may be a star or a flower or the like, may be coordinated with the layer's design pattern or not. The array of perforations 22 may alternatively be provided to represent a word as illustrated in FIG. 3d. The perforations 22 may also be of uniform size and shape or not. The perforations 22 are preferably void spaces that have been punched out using a punching machine, but they may alternatively include a transparent or translucent material if desired. It is also possible to extrude the core in a translucent material.

It should be understood that the perforations may have a variety of shapes, be it is circle, square, triangular, rectangular, oblong, or any other shape.

Referring now to FIG. 5, the perforations 22 have a diameter of Wₕ and a depth corresponding to at least the thickness T_{c} of the core 12. The diameter Wₕ of each perforation 22 is preferably between about 0.010 inches and about 0.5 inches or a combination of different diameters. Optionally, the diameter Wₕ of each perforation is between about 0.02 inches and 0.07 inches.

Referring to FIGS. 5-8c, walls 24 of the perforations 22 may be generally perpendicular to the first 14 and second 16 surfaces of the core 12. Alternatively, they may have another configuration.

The percent openness of the louver 10 may be between about 1% and about 50%. Optionally, the percent openness of the louver 10 may be between about 2% and about 30%.

At this point, the transmission and reflection effects of the preferred embodiments of the louver will be described in greater detail.

### Light Transmission Effects

Referring to FIGS. 6a and 6b, the light from outside is reflected by the second surface 16 of the core 12 except for the portion of light that passes through the perforation 22.

FIG. 6a illustrates the louver 10 in a “closed” position in which it covers the maximum surface area of the opening (not shown). In the closed position, the perforation 22 is oriented to allow the maximum amount of light to pass through it. In most applications, the incident light comes from the outside environment, rather than an adjacent architectural enclosure, and the light can often be considered parallel.

FIG. 6b illustrates the louver 10 in a “partially open” position as it has been rotated clockwise from the closed position. The perforations 22 undergo a corresponding rotation. The geometry of the perforation 22 and in this case one of the projections reduce the effective size of the gap through which the light is able to pass. Thus, as the louvers open, the space in between each louver may increase, but the gap for passage of light through the perforations 22 decreases. The projections 20 located adjacent to the inwardly-rotated side of the perforations (the left side as illustrated) may thus influence the size of the gap and the amount of light transmitted through the louver.

### Light Reflection Effects

Referring to FIGS. 7a and 7b, the light from within the architectural space is reflected by the layer 18 or passes through the perforations 22.

FIG. 7a illustrates the louver 10 in a “closed” position in which it covers the maximum surface area of the opening (not shown). In the closed position, the incident light is reflected according to the color and the design pattern of the layer 18. Since the design pattern of the layer 18 includes a plurality of projections 20 and consequent recesses, the incident light is absorbed or reflected according to their arrangement and properties. In the embodiment illustrated in FIG. 7a, some of the incident light is scattered in various directions so that the viewer may see a certain appearance of the design pattern.

FIG. 7b illustrates the louver 10 in a “partially open” position as it has been rotated clockwise from the closed position. The projections 20 undergo a corresponding rotation and their geometry and material properties result in a different light scattering so that the viewer may see a different appearance of the design pattern from FIG. 7a.

### Relative Indoor-Outdoor Lighting Effects

It is worthwhile to note that the viewer's ability to see the design pattern of the louver depends on the relative lighting inside and outside the architectural space.

When the outside is dark and the inside is illuminated, a viewer looking from within is able to view the design pattern clearly. The louvers thus provide decoration to an inside viewer. A viewer looking from outside, however, is able to see through the louvers due to the light transmission through the perforations toward the outside.

When the outside is light and the inside is dark, a viewer looking from within is not able to view the design pattern clearly, but rather views the outside environment in a shaded yet clear manner through the perforations. The louvers thus provide a semi-transparent screen effect to an inside viewer. A viewer looking from the outside, however, is not able to see through the louvers due to the overwhelming light reflectance off the second surface of the core. This provides increased privacy for the interior space. When the core is white or off-white, there is an increased amount of outside reflectance.

There are also conditions in which both the outside and inside are illuminated, which is the case in many daytime functional spaces such as offices, restaurants, stores, domestic apartments and houses, among others. For such cases, let us first consider when the louvers are in the closed position. Here, the design pattern appearance will depend on the difference between inside and outside lighting and the size and frequency of the perforations or the percent openness of the perforated louver. Often, during the daytime the outside light is sufficient to render the perforated louver semi-transparent and to substantially obscure the design pattern for an inside viewer.

Now let us consider when the louvers are rotated toward the partially open position. As the louver rotates, the gap provided by the perforations reduces in size, thus allowing less light to pass inside. At the same time, the interior light is reflected back at the inside viewer at different scattering patterns. Not only does the design pattern reflectance change, but also many of the projections of the design layer allow more rapid closure of the gap. Thus, as the louvers are rotated to a partially open position, there is a sudden and noticeable change in appearance from semi-transparent to crisp design.

Indeed, since the perception and observation of viewers is largely reliant on contrast and comparison in time and space, this sudden change of appearance due to reduced transmittance from the outside and increased proportion of reflection on the inside, is advantageous for registering with viewers. In some embodiments, only a slight rotation of the louvers allows a desired observable transition from semi-transparent to crisp design appearance.

It should be understood that sundry lighting and design appearance effects are possible depending on the color of outside and inside light, the color(s) of the louver design pattern(s), the arrangement of the perforations, and the dimensions of the core, layer, perforations, and projections. For instance, the interior light color may be modified or controlled to be the same as one of the colors of the design pattern to produce a certain kind of appearance transition when the louvers are rotated.

Referring to FIGS. 5-7b, in one embodiment of the louver 10 each perforation 22 is defined by a wall 24 and at least some of the projections 20 have edges 26 each defining a continuous co-planar surface with the wall 24 of the corresponding perforation 22. The co-planar surface takes the shape of the perforation. This co-planar surface formed by the wall 24 and the edge 26 allows various ameliorations. For instance, such co-planarity ensures that any inward rotation of that side of the louver will decrease the gap size more than without a layer. The height of the edge 26 (shown as Tₚ in FIG. 5) may also be more easily calculated or estimated for tailored creation of louvers.

The edges 26 that are continuous and co-planar with the walls 24 of the perforations 22 may extend away from the core 12 to a height of about T. These edges 26 may have a preferred height from the core 12 dependent upon the diameter of the perforations 22 and the thickness of the core 12, according to the following relationship: Tₚ≦2T_{c}. In addition, T_{c} may have a preferred thickness depending on the width of the perforation, where Wₕₘᵢₙ≦T_{c}≦Wₕₘₐₓ. The Wₕ preferred maximum and minimum values are mentioned above.

Preferably, at least some of the projections 20 have remote surfaces 28 each facing away from a corresponding perforation 22. Preferably, some of the remote surfaces 28 extend away from a corresponding perforation 22 and slope toward the core 12, as shown in FIG. 5 for example.

Referring to FIGS. 5-8c, the projections 20 may have a variety of shapes and configurations. They may be square, rounded, triangular or another shape viewed in cross-section. They may be granular or uneven or have defined geometric borders.

Referring to FIG. 8a, the projections 20 may be in a coordinated and repeated arrangement relative to the perforations 22.

Referring to FIGS. 8b and 8c, the projections 20 may be off-set from the array of perforations 22 such that only a fraction of the perforations 22 have walls that are continuous and co-planar with the edge of a corresponding projection 20.

The layer 18 and the core 12 may be composed of different materials. The core 12 may be generally white and the layer may be a different color or colors. The layer 18 may have a lower light reflectivity than the core 12 and/or a higher proportion of diffuse reflection than the core 12.

Integral cores, such as extrusions, are able to provide various improved properties, such as cleaning ability, reduced flammability, etc. with respect to other types of materials.

In another aspect of the present invention, as shown in FIG. 9, there is an assembly 30 that may be used in connection with any one of the louver embodiments described hereinabove. The assembly 30 includes a support 32 mountable to a frame 34 of an opening and a plurality of louvers 10 arranged side-by-side. The louvers 10 have first 36 and second 38 ends, each of the first ends being mountable to the support 32 so that the louvers 10 cover the opening. The louvers 10 may hang vertically (as illustrated) or be supported horizontally or be supported in another configuration.

The assembly 30 also includes rotation members 40 for rotating the louvers 10 between at least a closed position and a partially open position. The rotation members 40 may include rack bars, cord or chain mechanisms, wands or shafts, carriages, etc., depending on vertical or horizontal orientation of the louvers.

Referring to FIGS. 5-8c, preferably each second surface 16 of the cores 12 is white and smooth, and the rotation members of the assembly allow the louvers 10 to be rotated at least 180°, thus allowing the decorative layer 18 to face outward and the neutral colored surface inward when desired.

Referring to FIG. 10, the louvers 10 may be manufactured by extruding a thermoplastic resin in an extruder 42 through a die 44; coloring, embossing and/or printing the design pattern using rollers 46; cooling the extrusion 47 with air blowers 48 and/or water and giving it a given profile shape with shaping elements 50; once the extrusion is rigid enough, punching perforations in it using a punch unit 52; and then cutting the extrusion into individual louvers 10 with a cutting device 54.

It should be noted that the layer may include several strata or “component layers”. For instance, the core may be embossed to form a first stratum, and then colorant may be applied in a certain pattern to form a second stratum. Different combinations of strata may make up the layer at different locations over the surface of the core.

It should be understood that many modifications to the embodiments herein described may be made without departing from what has actually been invented.

1. A louver comprising:
an integral core having first and second opposed surfaces;
a layer provided on at least a portion of at least the first surface of the core, the layer having a design pattern comprising a plurality of projections extending away from the core;
an array of light-traversable perforations extending through the core and the layer.

2. The louver of claim 1, wherein the perforations have a diameter between about 0.01 inch and about 0.5 inch.

3. The louver of claim 2, wherein the perforations have a diameter between about 0.02 inch and about 0.07 inch.

4. The louver of claim 3, wherein the array of perforations has a staggered pattern type, a straight pattern type, a random pattern type or an ornamental pattern.

5. The louver of claim 4, wherein the percent openness of the louver is between about 1% and about 50%.

6. The louver of claim 5, wherein the percent openness of the louver is between about 2% and about 30%.

7. The louver of claim 1, wherein each perforation is defined by a wall and at least some of the projections have edges each defining a continuous co-planar surface with the wall of a corresponding perforation

8. The louver of claim 7, wherein the design pattern of the projections is off-set from the array of perforations such that only a fraction of the perforations have walls that are continuous and co-planar with the edge of a corresponding projection.

9. The louver of claim 6, wherein the walls of the perforations are generally perpendicular to the first and second surfaces of the core.

10. The louver of claim 7, wherein each edge that is continuous and co-planar with a corresponding wall extends away from the core a maximum of twice the distance of the thickness of the core.

11. The louver of claim 10, wherein the thickness of the core is between about 0.01 inch and about 0.5 inch.

12. The louver of claim 1, wherein each perforation is defined by a wall and at least some of the projections have remote surfaces each facing away from a corresponding perforation.

13. The louver of claim 12, wherein at least some of the remote surfaces slope toward the core.

14. The louver of claim 1, wherein the perforations are void spaces and allow direct passage of light therethrough.

15. The louver of claim 1, wherein the core has a thickness between about 0.01 inch and about 0.25 inch

16. The louver of claim 1, wherein the layer has a thickness below about 0.25 inch.

17. The louver of claim 1, wherein the layer is composed of a different material than the core, has a lower light reflectivity than the core and/or a higher diffuse reflectivity than the core.

18. The louver of claim 1, wherein the core is generally white or neutral and the layer comprises at least one other color.

19. The louver of claim 1, wherein the layer and the core form a one-piece structure.

20. The louver of claim 19, wherein the layer and the core are formed from an extrusion of thermoplastic resin, wherein the layer is defined by embossing the extrusion to form the projections and/or by coloring and printing at least one colorant onto the core.

21. The louver of claim 19, wherein the layer is defined by a co-extrusion with the core, a laminate applied to the core, and/or a colorant applied to the core.

22. The louver of claim 1, wherein the layer comprises at least two strata.

23. The louver of claim 1, wherein the core and the layer have an arced cross-section that is convex facing in the same direction as the layer, concave, S-shaped, bell-shaped or flat.

24. An assembly comprising:
a support mountable to a frame of an opening;
a plurality of louvers as defined in claim 1 the louvers being mountable relative to the support so that the louvers cover the opening;
rotation members for rotating the louvers between at least a closed position and a partially open position.

25. The assembly of claim 24, wherein the louvers are mounted to the support to hang vertically.

26. The assembly of claim 24, wherein the louvers are hung horizontally from the support.

27. The assembly of claim 24, wherein the second surface of the core is white or neutral and smooth, and the rotation members allow the louvers to be rotated at least 180°.
